(19) United States
(12) Patent Application Publication
(10) Pub. No.: US 2022/0265086 A1
(43) Pub. Date: Aug. 25, 2022

(54) APPARATUS FOR COOKING BACON AND THE LIKE INSIDE MICROWAVE OVENS

(71) Applicant: Gary R. Kerr, Covina, CA (US)

(72) Inventor: Gary R. Kerr, Covina, CA (US)

(21) Appl. No.: 17/679,076

(22) Filed: Feb. 23, 2022

Related U.S. Application Data
(60) Provisional application No. 63/152,566, filed on Feb. 23, 2021.

(51) Int. Cl. A47J 36/02; A47J 36/06; A47J 43/18; H05B 6/64

(52) U.S. Cl. CPC A47J 36/027; A47J 36/06; A47J 43/18; H05B 6/6408

(57) ABSTRACT

The present invention is an apparatus for cooking bacon and the like inside microwave ovens. The apparatus includes a pan, a cover, and at least one support. The apparatus may also include a grease vessel. The apparatus may be placed in an open position and a closed position. In a non-limiting embodiment, the apparatus includes a pan, a cover or lid, and four supports. Preferably, the pan includes a snout and at least one handle. In another non-limiting embodiment, the apparatus includes a pan, a cover or lid, and two supports. Preferably, the pan includes a snout and at least one handle. During use, at least one of the supports is positioned and secured within the pan; the bacon and the like is positioned upon the supports; and the pan and cover or lid are positioned in a closed position with one another.

### CROSS-REFERENCE TO RELATED APPLICATIONS

The present application claims the priority benefit of U.S. Provisional Patent Application Ser. No. 63/152,566, filed on Feb. 23, 2021 and titled “The Best Little Bacon Cooker,” which is incorporated herein by reference in its entirety.

### BACKGROUND OF THE INVENTION

### Field of the Invention

The present invention generally relates to covers, devices, apparatuses, and systems for cooking and/or heating food and drinks inside microwave ovens. More specifically, the present invention is an apparatus for cooking bacon and the like inside microwave ovens.

### Description of the Related Art

Covers, devices, apparatuses, and systems for cooking and/or heating food and drinks inside microwave ovens are known in the art.

Cooking bacon inside a microwave oven is ideal to save time. However the process can be messy and involve several steps. Often times, it is not possible to cook an entire package of bacon in a microwave oven at once due to space constraints. The collection and disposal of grease also has to be done multiple times, which is inconvenient. Preventing the bacon from splattering grease inside the microwave oven during cooking can also be difficult.

The present invention overcomes one or more of the shortcomings of covers, devices, apparatuses, and systems for cooking bacon and the like inside microwave ovens. The Applicant is unaware of inventions or patent documents, taken either singly or in combination, which are seen to describe the present invention as claimed.

One advantage of the present invention is that it allows for a user to cook a fair amount of bacon and the like, such as, but not limited to, an entire package (about twelve or sixteen ounces) of bacon, inside microwave ovens.

Another advantage of the present invention is that it allows for a user to quickly cook bacon and the like.

A further advantage of the present invention is that it allows for a user to cook bacon and the like without the use of frying pans, skillets, oven pans, and the like.

An additional advantage of the present invention is that it allows for a user to cook bacon and the like while minimizing splatters and messes.

Another advantage of the present invention is that it allows for a user to wash some or all of the components of the apparatus in a dishwasher, especially when the components of the apparatus are made or manufactured of a dishwasher safe material(s).

A further advantage of the present invention is that it allows for a user to wash some or all of the apparatus in a dishwasher, especially when the cover or lid is removable/detachable and the at least one support is removable/detachable or non-removable/non-detachable.

### SUMMARY OF THE INVENTION

The present invention is an apparatus for cooking bacon and the like inside microwave ovens that comprises or includes a pan, a cover or lid (removable/detachable or non-removable/non-detachable), and at least one support (removable/detachable or non-removable/non-detachable). The apparatus may also comprise or include a fluid or grease vessel. The apparatus may be placed in an open position (fully open or partially open; such as when bacon and the like are being loaded onto the pan for being cooked) and a closed position (such as when bacon and the like are being cooked in a microwave oven).

In a non-limiting embodiment, the apparatus comprises or includes a pan, a removable/detachable cover or lid, and four supports (removable/detachable or non-removable/non-detachable). Preferably, the pan comprises or includes a snout and at least one handle. During use, at least one of the supports is positioned and secured within the pan, and the pan and removable/detachable cover or lid are positioned in a closed position with one another.

In another non-limiting embodiment, the apparatus comprises or includes a pan, a removable/detachable cover or lid, and two supports (removable/detachable or non-removable/non-detachable). Preferably, the pan comprises or includes a snout and at least one handle. During use, at least one of the supports is positioned and secured within the pan, and the pan and removable/detachable cover or lid are positioned in a closed position with one another.

### BRIEF DESCRIPTION OF THE DRAWINGS

FIG. 1 is an environmental, perspective view of an embodiment of an apparatus for cooking bacon and the like inside microwave ovens according to the present invention, wherein the apparatus is in an open position, wherein four supports are positioned and secured within a pan, and wherein a removable cover and the pan are positioned separately from one another;

FIG. 2 is a perspective view of the apparatus of FIG. 1, wherein the apparatus is in an open position, and wherein the removable cover and the pan are positioned separately from one another;

FIG. 3 is a perspective view of the apparatus of FIG. 1, wherein the apparatus is in a closed position, and wherein the removable cover and the pan are positioned together for use or for being stowed away;

FIG. 4 is a front perspective view of the pan of the apparatus of FIG. 1;

FIG. 5 is an environmental, perspective view of the pan of FIG. 4;

FIG. 6 is an environmental, perspective view of another embodiment of an apparatus for cooking bacon and the like inside microwave ovens according to the present invention, wherein the apparatus is in an open position, wherein two supports are positioned and secured within a pan, and wherein a removable cover and the pan are positioned separately from one another;

FIG. 7 is a perspective view of the apparatus of FIG. 6, wherein the apparatus is in an open position, and wherein the removable cover and the pan are positioned separately from one another;

FIG. 8 is a perspective view of the apparatus of FIG. 6, wherein the apparatus is in a closed position, and wherein the removable cover and the pan are positioned together for use or for being stowed away;

FIG. 9 is a front perspective view of the pan of the apparatus of FIG. 6; and

FIG. 10 is an environmental, perspective view of the pan of FIG. 9.

It should be understood that the above-attached figures are not intended to limit the scope of the present invention in any way.

### DETAILED DESCRIPTION OF THE EMBODIMENTS OF THE PRESENT INVENTION

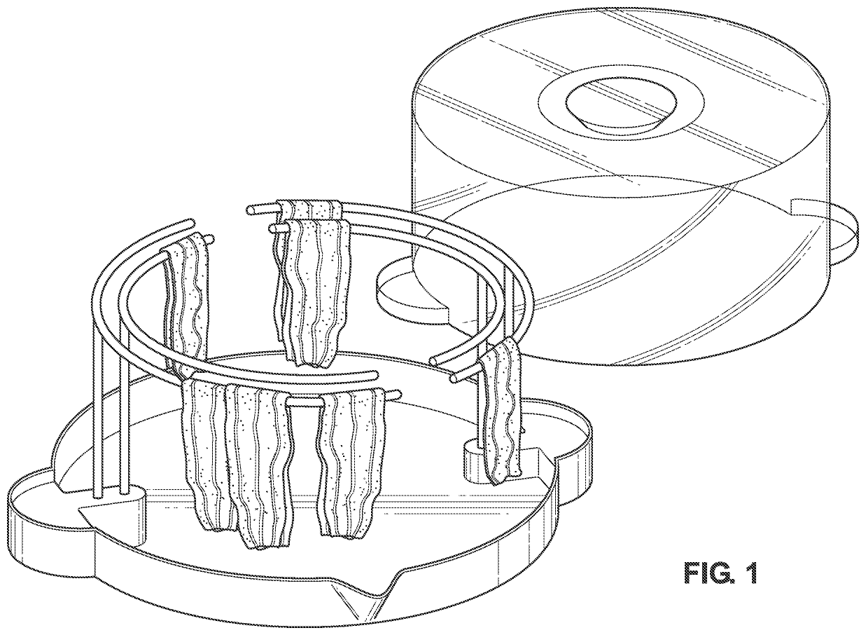

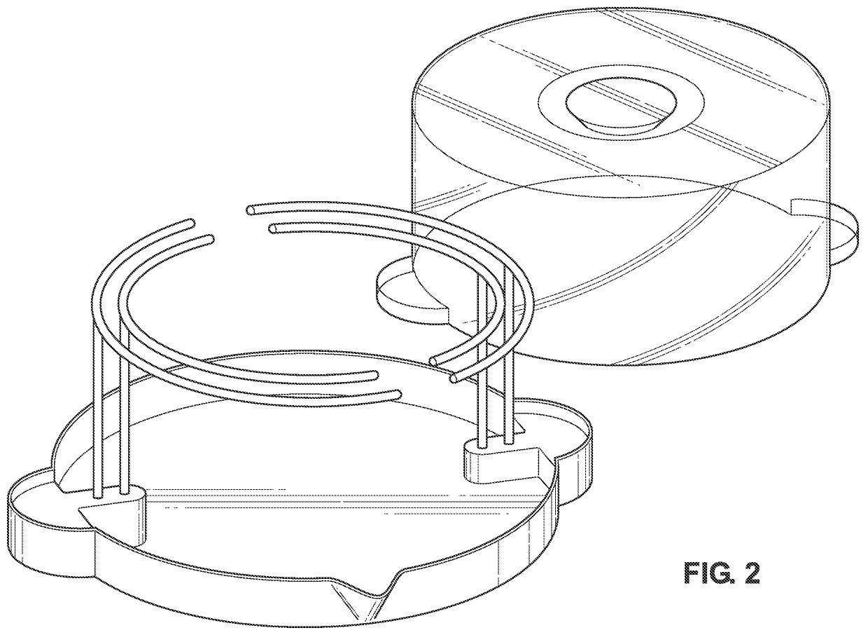

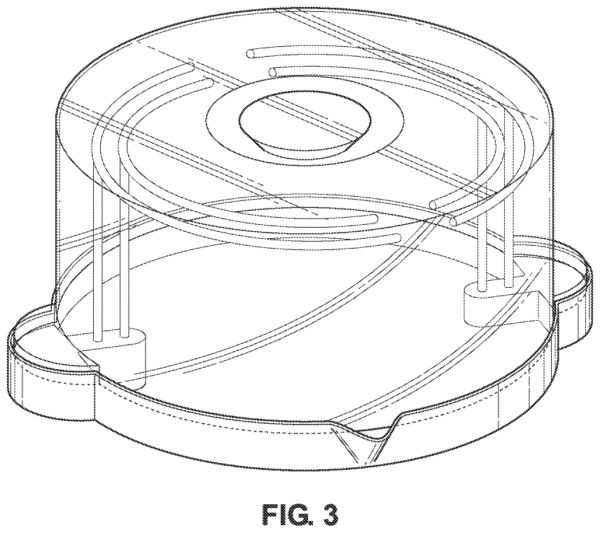

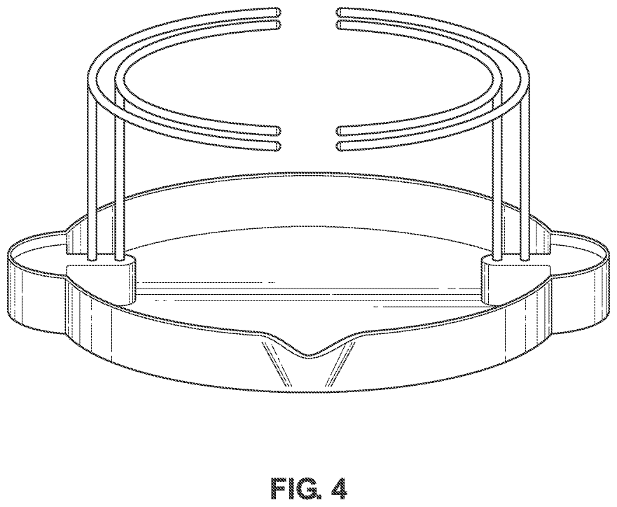

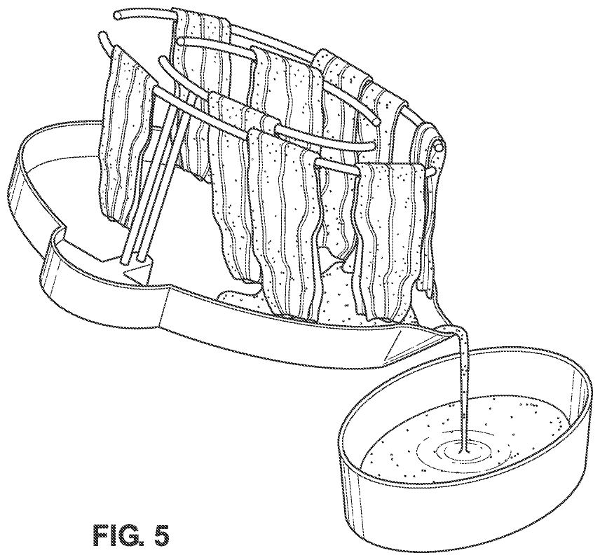

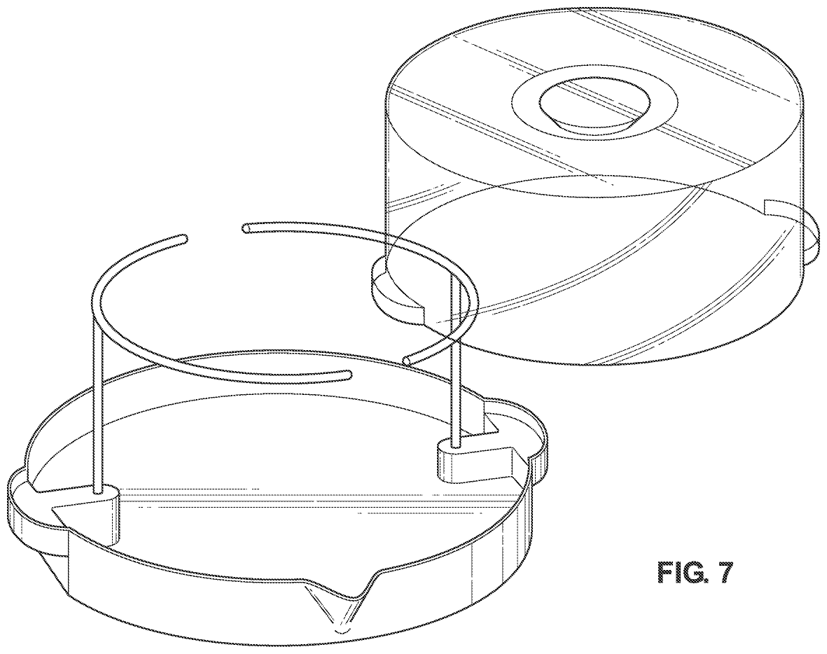

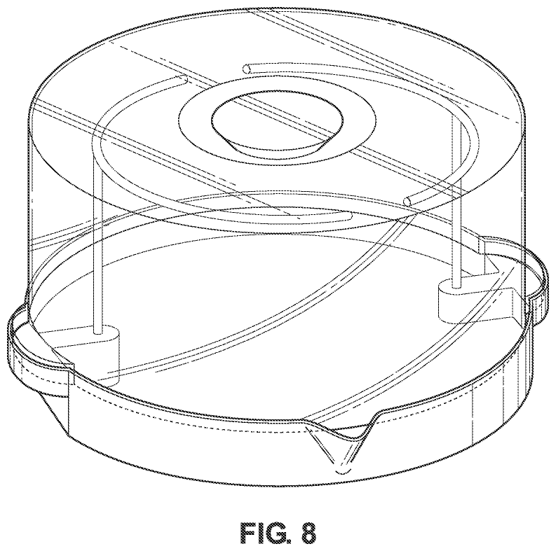

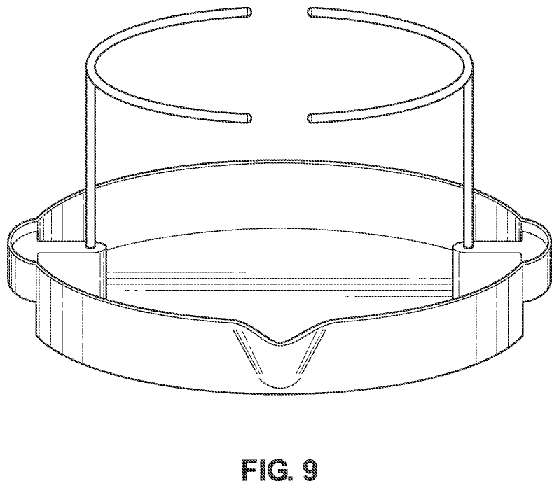

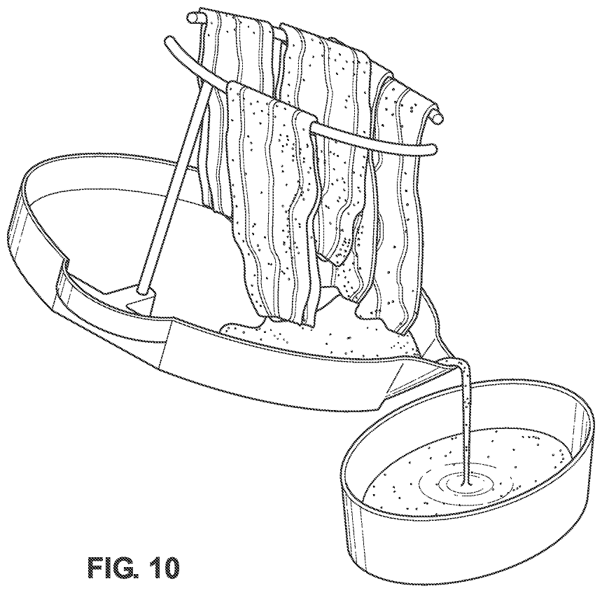

Referring to FIGS. 1-10, the present invention is an apparatus 100,200 for cooking bacon and the like inside microwave ovens that comprises or includes a pan 110,210, a cover or lid 150,250 (removable/detachable or non-removable/non-detachable), and at least one support 170,270 (removable/detachable or non-removable/non-detachable). The apparatus 100,200 may also comprise or include a fluid or grease vessel 190,290. The apparatus 100,200 may be placed in an open position (fully open or partially open; such as when bacon BAC and the like are being loaded onto the pan 110,210 for being cooked) and a closed position (such as when bacon BAC and the like are being cooked in a microwave oven).

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

As a non-limiting embodiment and as shown in FIGS. 1-5, the apparatus 100 comprises or includes a pan 110, a cover or lid 150 (preferably removable/detachable), and four supports or support legs 170 (preferably removable/detachable). The apparatus 100 may also comprise or include a fluid or grease vessel 190.

Preferably, as a non-limiting example, the pan 110 comprises or includes a front 112, a rear 114, a pair of sides 116,118, a top surface 120, a bottom surface 122, a pair of raised support securing elements 124,126 (with at least one hole or port 128,129), a snout or lip 130, and at least one handle 140,142 (preferably a pair of handles). The pan 110 is dimensioned and configured for receiving the supports 170 and bacon and other foods that may be cooked on the supports 170 and pan 110 and/or also to receive the cover or lid 150 when the apparatus 100 is placed in the closed position for cooking or being stowed away. Preferably, the pan 110 has sufficient strength to receive the supports 170 and bacon and other foods that may be cooked on the supports 170 and pan 110 and/or also to receive the cover or lid 150. As a non-limiting example, the pan 110 has a circular configuration. However, the pan 110 may have any other configuration that allows it to fit into many, most or all microwave ovens. As a non-limiting example, the pan may be about 5″ in diameter and about 1″ deep. Of course, other dimensions are possible to fit inside many, most or all microwave ovens.

Preferably, there are four holes or ports 128,129, with two corresponding holes 128,129 located about each of the sides 116,118 of the pan 110 and are dimensioned and configured for receiving and detachably securing a corresponding end of a corresponding support 170.

Preferably, each of the pair of raised support securing elements 124,126 is located about the corresponding side 116,118 of the pan 110, and include two corresponding holes or ports 128,129.

The snout or lip 130 extends outward from the pan 110 and allows a user to readily remove fluid, grease and drippings from the pan 110 after cooking.

Preferably, each of the pair of handles 140,142 extends outward from the pan 110 to provide the user with easier handling of the pan 110, and is located about the sides 116,118 of the pan 110.

Preferably, as a non-limiting example, the cover or lid 150 is a removable/detachable cover or lid 150 that comprises or includes a top 152 (having a perimeter 154), a sidewall 156 (extending downward from the perimeter 154 of the top 152), and a height H. The top 152 has a full circle configuration. The removable/detachable cover or lid 150 is dimensioned and configured for covering the supports 170 and bacon and other foods that may be cooked on the supports 170 and pan 110, for fitting with the pan 110 when the apparatus 100 is placed in the closed position for use, and for preventing splatters and messes during use.

Preferably, as a non-limiting example, each of the four supports or support legs 170 is a removable/detachable support 170. Each support 170 has a vertical extension or body 172 (with first and second ends 174,175) and a semi-circular body 176 secured or extended from the second end 175. Corresponding first ends 174 are inserted into and secured at corresponding holes or ports 128,129 on preferably the opposite sides of the pan 110 such that the corresponding supports 170 form almost a full-circle type configurtation for use. The supports 170 are dimensioned and configured and has sufficient strength to receive and withstand bacon, foods, and the like be positioned on the semi-circular body 176 during use. As a non-limitng example, each of the supports 170 may be about 4″ high. Of course, other dimensions are possible to fit inside many, most or all microwave ovens.

The fluid or grease vessel 190 is dimensioned and configured for receiving some or all of the fluid, grease and drippings from the pan 110 after cooking.

During use, at least one (preferably all) of the supports 170 is positioned and secured within the pan 110; bacon strips, foods, and the like is/are positioned on the semi-circular body 176 of the supports 170; the pan 110 and removable/detachable cover or lid 150 are positioned in a closed position with one another; and the grease drips to the bottom of the pan 110.

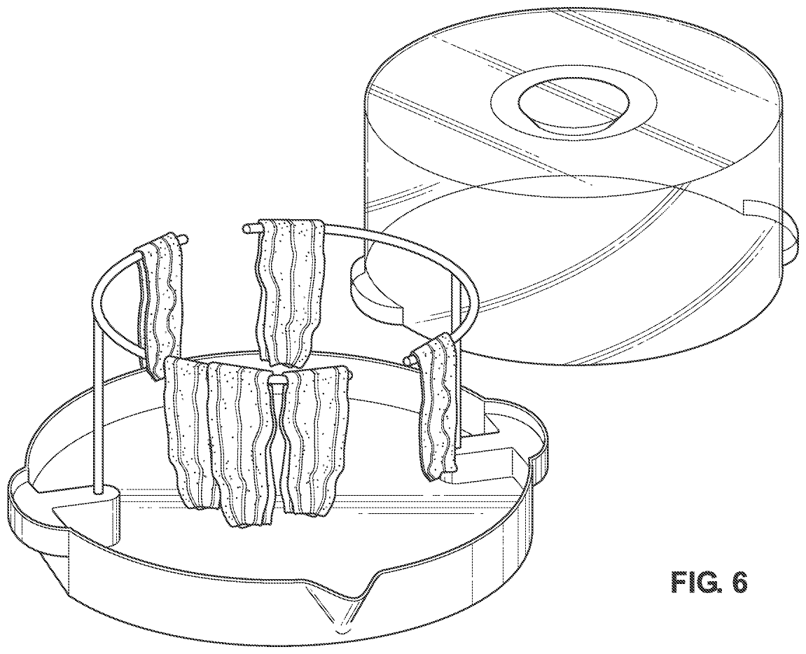

As another non-limiting embodiment and as shown in FIGS. 6-10, the apparatus 200 comprises or includes a pan 210, a cover or lid 250 (preferably removable/detachable), and two supports or support legs 270 (preferably removable/detachable). The apparatus 200 may also comprise or include a fluid or grease vessel 290.

Preferably, as a non-limiting example, the pan 210 comprises or includes a front 212, a rear 214, a pair of sides 216,218, a top surface 220, a bottom surface 222, a pair of raised support securing elements 224,226 (with at least one hole or port 228,229), a snout or lip 230, and at least one handle 240,242 (preferably a pair of handles). The pan 210 is dimensioned and configured for receiving the supports 270 and bacon and other foods that may be cooked on the supports 270 and pan 210 and/or also to receive the cover or lid 250 when the apparatus 200 is placed in the closed position for cooking or being stowed away. Preferably, the pan 210 has sufficient strength to receive the supports 270 and bacon and other foods that may be cooked on the supports 270 and pan 210 and/or also to receive the cover or lid 250. As a non-limiting example, the pan 210 has a circular configuration. However, the pan 210 may have any other configuration that allows it to fit into many, most or all microwave ovens. As a non-limiting example, the pan may be about 5″ in diameter and about 1″ deep. Of course, other dimensions are possible to fit inside many, most or all microwave ovens.

Preferably, there are four holes or ports 228,229, with two corresponding holes 228,229 located about each of the sides 216,218 of the pan 210 and are dimensioned and configured for receiving and detachably securing a corresponding end of a corresponding support 270.

Preferably, each of the pair of raised support securing elements 224,226 is located about the corresponding side 216,218 of the pan 210, and include two corresponding holes or ports 228,229.

The snout or lip 230 extends outward from the pan 210 and allows a user to readily remove fluid, grease and drippings from the pan 210 after cooking.

Preferably, each of the pair of handles 240,242 extends outward from the pan 210 to provide the user with easier handling of the pan 210, and is located about the sides 216,218 of the pan 210. The handles 240,242 in this embodiment are similar to handles 140,142 but differ in that handles 240,242 extend a shorter length from the pan 210 and has some clearance distance from the bottom surface of the pan 210.

Preferably, as a non-limiting example, the cover or lid 250 is a removable/detachable cover or lid 250 that comprises or includes a top 252 (having a perimeter 254), a sidewall 256 (extending downward from the perimeter 254 of the top 252), and a height HH. The top 252 has a full circle configuration. The removable/detachable cover or lid 250 is dimensioned and configured for covering the supports 270 and bacon and other foods that may be cooked on the supports 270 and pan 210, for fitting with the pan 210 when the apparatus 200 is placed in the closed position for use, and for preventing splatters and messes during use.

Preferably, as a non-limiting example, each of the four supports or support legs 270 is a removable/detachable support 270. Each support 270 has a vertical extension or body 272 (with first and second ends 274,275) and a semi-circular body 276 secured or extended from the second end 275. Corresponding first ends 274 are inserted into and secured at corresponding holes or ports 228,229 on preferably the opposite sides of the pan 210 such that the corresponding supports 270 form almost a full-circle type configurtation for use. The supports 270 are dimensioned and configured and has sufficient strength to receive and withstand bacon, foods, and the like be positioned on the semi-circular body 276 during use. As a non-limitng example, each of the supports 270 may be about 4″ high. Of course, other dimensions are possible to fit inside many, most or all microwave ovens.

The fluid or grease vessel 290 is dimensioned and configured for receiving some or all of the fluid, grease and drippings from the pan 110 after cooking.

During use, at least one (preferably all) of the supports 270 is positioned and secured within the pan 210; bacon strips, foods, and the like is/are positioned on the semi-circular body 276 of the supports 270; the pan 210 and removable/detachable cover or lid 250 are positioned in a closed position with one another; and the grease drips to the bottom of the pan 210.

The components of the apparatus 100,200 may be made or manufactured of plastic, glass, any material known to one of ordinary skill in the art (OOSIA), and any combination thereof. Preferably, the components of the apparatus 100 may be made or manufactured of a material(s) that is/are dishwater safe.

What has been described above includes examples of the claimed subject matter. It is, of course, not possible to describe every conceivable combination of components or methodologies for purposes of describing the claimed subject matter, but one of ordinary skill in the art (OOSIA) may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

It is to be understood that the present invention is not limited to the embodiments and aspects described above or as shown in the attached figures, but encompasses any and all embodiments and aspects within the spirit of the invention.

1. An apparatus for cooking bacon and the like inside microwave ovens, said apparatus comprising:
a pan comprising a top surface and a bottom surface,
wherein said pan is dimensioned and configured for retaining fluid and grease during use, and
wherein said pan is dimensioned and configured for receiving at least one bacon support and bacon and other foods that may be cooked on said bacon support during use wherein said pan is dimensioned and configured for receiving at least one bacon support and bacon and other foods that may be cooked on said bacon support during use;
a cover or lid; and
said at least one bacon support for supporting bacon and other foods that may be cooked on said bacon support during use.

2. The apparatus according to claim 1, wherein said pan further comprises at least one raised support securing element.

3. The apparatus according to claim 1, wherein said pan further comprises a snout or lip.

4. The apparatus according to claim 1, wherein said pan further comprises at least one handle.

5. The apparatus according to claim 1, wherein said pan has a circular configuration.

6. The apparatus according to claim 1, wherein said cover or lid is a removable cover or lid.

7. The apparatus according to claim 1, further comprising a fluid or grease vessel.

8. An apparatus for cooking bacon and the like inside microwave ovens, said apparatus comprising:
a pan comprising a front, a rear, a pair of sides, a top surface, a bottom surface,
wherein said pan is dimensioned and configured for receiving at least one bacon support and bacon and other foods that may be cooked on said bacon support during use;
a cover or lid; and
said at least one bacon support for supporting bacon and other foods that may be cooked on said bacon support during use.

9. The apparatus according to claim 8, wherein said pan further comprises at least one raised support securing element.

10. The apparatus according to claim 8, wherein said pan further comprises a snout or lip.

11. The apparatus according to claim 8, wherein said pan further comprises at least one handle.

12. The apparatus according to claim 8, wherein said pan has a circular configuration.

13. The apparatus according to claim 8, wherein said cover or lid is a removable cover or lid.

14. The apparatus according to claim 8, further comprising a fluid or grease vessel.
